(19) United States
(12) Patent Application Publication
(10) Pub. No.: US 2008/0217360 A1
(43) Pub. Date: Sep. 11, 2008

(54) Hot melt adhesive dispensing valve or module assembly having a module filter disposed therewithin

(75) Inventors: Mairi MacLean, Hendersonville, TN (US); Edward W. Bolyard, Old Hickory, TN (US)

Correspondence Address: Steven W. Weinrieb;LAW OFFICES OF STEVEN W.WEINRIEB, 8717 Cold Spring Road, Potomac, MD, 20854, US

(73) Assignee: ILLINOIS TOOL WORKS INC.

(21) Appl. No.: 11/713,716

(22) Filed: Mar. 5, 2007

(51) Int. Cl. B67D 5/58

(52) U.S. Cl. 222/189.06

(57) ABSTRACT

A module filter is mounted upon a module housing of a dispensing valve assembly at a position which is disposed substantially immediately upstream of the dispensing valve assembly nozzle, but at a position which is effectively offset from the longitudinal axis of the dispensing valve assembly nozzle, so as to not only be readily externally accessible, but in addition, the module filter is also effectively independent of the dispensing valve assembly nozzle such that the dispensing valve assembly nozzle does not have to be removed from the dispensing valve assembly in order to gain access to the module filter. The module filter may be secured within the dispensing valve assembly housing by an O-ring member, or alternatively, the module filter may be integral with the O-ring member.

### FIELD OF THE INVENTION

The present invention relates generally to fluid dispensing valve assemblies, such as, for example, hot melt adhesive or other thermoplastic material dispensing valve assemblies, and more particularly to a new and improved hot melt adhesive or other thermoplastic material dispensing valve or module assembly, which is operatively associated with and fixedly mounted upon the hot melt adhesive or other thermoplastic material applicator, and which has a new and improved module filter assembly disposed therewithin for trapping minute particles or debris which could otherwise clog or block the hot melt adhesive or other thermoplastic material dispensing valve assembly nozzle, wherein the new and improved module filter assembly is mounted upon or within the hot melt adhesive or other thermoplastic material dispensing valve or module assembly so as to not only be readily accessible when the hot melt adhesive or other thermoplastic material dispensing valve or module assembly is detached from the hot melt adhesive or other thermoplastic material applicator in connection with, for example, the performance of a filter removal, cleaning, or replacement operation, but in addition, the new and improved module filter assembly is mounted upon the hot melt adhesive or other thermoplastic material dispensing valve or module assembly so as to effectively be independent of the hot melt adhesive or other thermoplastic material dispensing valve assembly nozzle such that the hot melt adhesive or other thermoplastic dispensing valve assembly nozzle does not have to be detached or removed from the hot melt adhesive or other thermoplastic material dispensing valve or module assembly in order to gain access to the module filter assembly.

### BACKGROUND OF THE INVENTION

Fluid dispensing head assemblies, whether they are used for dispensing or depositing hot melt adhesives, plastic extrusion materials, cosmetic lotions, or the like, are of course well known. Such fluid dispensing head assemblies, such as, for example, hot melt adhesive dispensing head assemblies, normally comprise filter mechanisms or components which are disposed within a filter block to which a hot melt adhesive supply conduit is fixedly connected. More particularly, the filter mechanism or component is conventionally disposed within the filter block immediately downstream of the fluidic connection defined between the hot melt adhesive supply conduit and the filter block. While such filter component or mechanism therefore filters or entraps most particles or debris whereby such debris or particles do not contaminate the hot melt adhesive, debris or particles as small as, or smaller than, 0.005 inches sometimes find their way or migrate through the system, ultimately clogging or blocking nozzles which may have small orifices on the order of 0.010-0.015 inches in diameter. Such particles can be released, for example, during primary filter exchange or replacement operations whereby stagnant debris disposed around the filter component may be dislodged or otherwise stirred up or released. Alternatively, it has been found that such particles can nevertheless be formed within the hot melt adhesive dispensing head assembly, after the primary filtration has taken place within the aforenoted filter block, at positions upstream and remote from the dispensing valve assembly nozzle. Regardless of how such particles or debris are formed or find their way into the adhesive dispensing system, it is desirable to catch or entrap such particles before they enter the dispensing valve assembly nozzle.

A need therefore existed in the art for a removable inline nozzle filter which could effectively be incorporated within the dispensing valve or module assembly at a position or location immediately upstream of the dispensing valve assembly nozzle so as to catch, filter, or entrap any particles or debris which may nevertheless still be present within the system despite previous filtration of the hot melt adhesive material within the conventional filter block assembly at a position or location upstream and remote from the dispensing valve assembly nozzle. The aforenoted need was effectively met, for example, by means of the filter mechanism disclosed within U.S. Pat. No. 6,315,168 which was issued to Bolyard, Jr. et al. on Nov. 13, 2001, however, it is noted that such filter mechanism is not only inline with respect to the dispensing valve assembly nozzle, but in addition, and more importantly for the purposes of the present invention discussion, the filter mechanism is effectively secured within the dispensing valve or module assembly by means of the dispensing valve assembly nozzle so as to, in effect, be coaxially aligned with respect to the dispensing valve assembly nozzle. Accordingly, if the filter mechanism needs to be cleaned, replaced, or exchanged, the dispensing valve assembly nozzle must first be detached and removed from the dispensing valve assembly.

A further need, to which the present invention is addressed, therefore exists in the art for a removable inline filter mechanism, to be operatively and fluidically connected to the dispensing valve assembly nozzle, which can be mounted upon or incorporated within the dispensing valve or module assembly at a position or location which is located substantially immediately upstream of the dispensing valve assembly nozzle so as to catch, filter, or entrap any particles or debris which may nevertheless still be present within the system despite previous filtration of the hot melt adhesive or other thermoplastic material within the conventional filter block assembly at a position or location upstream and remote from the dispensing valve assembly nozzle, and yet the inline filter mechanism is to be mounted upon or incorporated within the dispensing valve or module assembly at a position or location which effectively renders the same positionally independent of the dispensing valve assembly nozzle such that if the filter mechanism needs to be removed from the dispensing valve or module assembly in order to be cleaned or replaced, the dispensing valve assembly nozzle need not first be detached or removed from the dispensing valve or module assembly.

### SUMMARY OF THE INVENTION

The foregoing and other objectives are achieved in accordance with the teachings and principles of the present invention through the provision of a new and improved hot melt adhesive or other thermoplastic material dispensing valve or module assembly which is operatively associated with and fixedly mounted upon the hot melt adhesive or other thermoplastic material applicator and which has a new and improved module filter assembly disposed therewithin for trapping minute particles or debris which could otherwise clog or block the hot melt adhesive or other thermoplastic material dispensing valve assembly nozzle. The new and improved module filter assembly is mounted upon or within a module housing or body of the dispensing valve or module assembly at a position which is disposed substantially immediately upstream of the dispensing valve assembly nozzle but at a position which is, in effect, offset from the longitudinal axis of the dispensing valve assembly nozzle so as to not only be readily accessible when the dispensing valve or module assembly is detached from the hot melt adhesive or other thermoplastic material applicator in connection with, for example, the performance of a filter removal, cleaning, or replacement operation, but in addition, the new and improved module filter assembly is also effectively independent of the dispensing valve assembly nozzle such that the dispensing valve assembly nozzle does not have to be detached or removed from the dispensing valve or module assembly in order to gain access to the module filter assembly. In accordance with a first embodiment of the module filter assembly, the module filter is secured within the dispensing valve assembly or module housing by means of an O-ring sealing member, while in accordance with a second embodiment of the module filter assembly, the module filter is disposed internally within the O-ring sealing member and forms an integral assembly therewith.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a perspective view, partially exploded, of a new and improved hot melt adhesive or other thermoplastic material dispensing valve or module assembly, which has been constructed in accordance with the principles and teachings of the present invention, which shows the cooperative parts thereof, and which has a first embodiment of a new and improved module filter assembly incorporated therein;

FIG. 2 is a perspective view of a second embodiment of a new and improved module filter assembly which has also been constructed in accordance with the principles and teachings of the present invention and which can likewise be incorporated within the new and improved hot melt adhesive or other thermoplastic material dispensing valve or module assembly as disclosed within FIG. 1;

FIG. 3 is a front elevational view of the new and improved module filter assembly as disclosed within FIG. 2; and

FIG. 4 is a cross-sectional view of the new and improved module filter assembly as disclosed within FIG. 3 and as taken along the lines 4-4 of FIG. 3.

### DETAILED DESCRIPTION OF THE PREFERRED EMBODIMENT

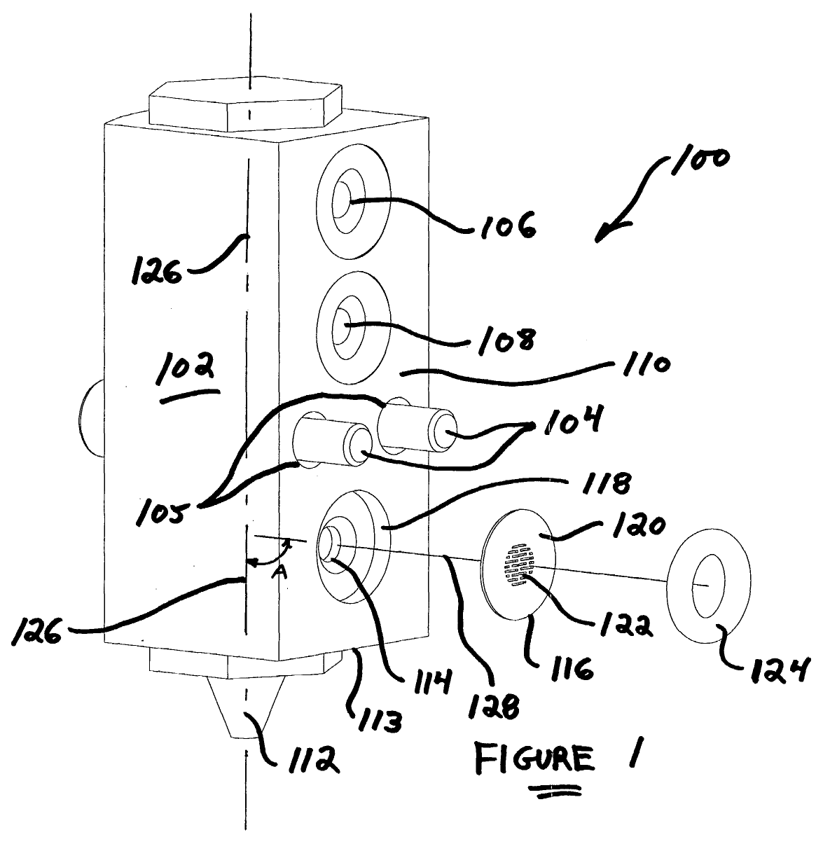

Referring now to the drawings, and more particularly to FIG. 1 thereof, a new and improved hot melt adhesive or other thermoplastic material dispensing valve or module assembly, which has been constructed in accordance with the principles and teachings of the present invention, is disclosed and is generally indicated by the reference character 100. More particularly, the hot melt adhesive or other thermoplastic material dispensing valve or module assembly 100 is similar to the hot melt adhesive dispensing valve or module assembly as disclosed within the aforenoted U.S. Pat. No. 6,315,168 which issued to Bolyard, Jr. et al. in that the same comprises a module housing or body 102 within which there is disposed a dispensing valve assembly which is not illustrated but which is similar to the dispensing valve assembly disclosed within the aforenoted U.S. Pat. No. 6,315,168 which issued to Bolyard, Jr. et al., the disclosure of which is hereby incorporated herein by reference.

The module housing or body 102 is adapted to be fixedly mounted upon an applicator head or the like, not shown, by means of, for example, a plurality of headed bolt fasteners 104,104 which are adapted to pass or extend through unthreaded bores 105,105 defined within the module housing or body 102, and it is also seen that the module housing or body 102 has first and second control air ports 106,108 which are defined in a recessed or countersunk manner within upper portions of a side wall member 110 of the module housing or body 102, wherein the first and second control air ports 106,108 respectively provide fluidic communication to the module body or housing 102 for incoming control air for controlling the movement of the dispensing valve assembly, not shown, between its lowered, seated position and its raised, unseated position. A hot melt adhesive or other thermoplastic material dispensing valve assembly nozzle 112 is adapted to be threadedly mounted within an underside or lower end wall portion 113 of the module housing or body 102, and accordingly, when the dispensing valve assembly, not shown, is disposed at its upper or raised, unseated position as a result of the control air being admitted into the control air port 108, the hot melt adhesive or other thermoplastic material is able to be dispensed from the dispensing valve assembly nozzle 112, whereas when the dispensing valve assembly, not shown, is disposed at its lowered or seated position as a result of the control air being admitted into the control air port 106, hot melt adhesive or other thermoplastic material is no longer able to be dispensed from the dispensing valve assembly nozzle 112.

Continuing further, the module housing or body 102 has a hot melt adhesive or other thermoplastic material inlet port 114 defined in a recessed or countersunk manner within the side wall member 110 of the module housing or body 102 at position located beneath the pair of unthreaded bores 105,105 defined within the module housing or body 102, and in accordance with further principles and teachings of the present invention, a first embodiment of a new and improved module filter assembly, comprising an inline filter member 116, is adapted to be disposed within the countersunk or recessed region 118 which is defined within the side wall member 110 of the module housing or body 102 and which surrounds the hot melt adhesive or other thermoplastic material inlet port 114. The filter member 116 may be fabricated from a suitable stainless steel and is seen to effectively comprise a circular disc having, for example, a radially outer solid annular portion 120 and an axially central porous or mesh portion 122. An O-ring sealing member 124 is also adapted to be operatively associated with the filter member 116 and the countersunk or recessed region 118 defined within the side wall member 110 of the module housing 102 in that once the filter member 116 is disposed within the countersunk or recessed region 118 of the side wall member 110 of the module housing or body 102, the O-ring sealing member 124 is adapted to be inserted in a substantially friction-fit manner within the recessed or countersunk region 118 of the side wall member 110 of the module housing or body 102 so as to effectively fixedly retain the filter member 116 within the countersunk or recessed region 118 of the side wall member 110 of the module housing or body 102.

In accordance with further teachings and principles of the present invention, it will also be noted that, contrary to the inline filter assembly, as disclosed within the aforenoted U.S. Pat. No. 6,315,168 which issued to Bolyard, Jr. et al., wherein the inline filter assembly was disposed immediately upstream of, and coaxially aligned with, the dispensing valve assembly nozzle, the filter member 116 of the present invention comprises an inline filter member which is disposed immediately upstream of the dispensing valve assembly nozzle 112, however, it is not coaxially aligned with the dispensing valve assembly nozzle 112. More particularly, as a result of the disposition of the dispensing valve assembly nozzle 112 being disposed within the underside or lower end wall portion 113 of the dispensing valve or module assembly housing or body 102, and as a result of the disposition of the filter member 116 being disposed within the side wall member 110 of the module housing or body 102, the filter member 116 is effectively disposed at an offset position with respect to the axis 126 of the dispensing valve assembly nozzle 112. It is seen, for example, that the axis 128 of the filter member 116 intersects the axis 126 of the dispensing valve assembly nozzle 112 at, for example, an angle A of approximately 90°. Therefore, while the filter member 116 comprises an inline filter member with respect to the dispensing valve assembly 112 as defined by means of the fluid flow path of the incoming hot melt adhesive or other thermoplastic material which extends from the applicator head or the like, not shown, into the hot melt adhesive or other thermoplastic material inlet port 114, and then to the dispensing valve assembly nozzle 112, it can also be readily appreciated that the inline filter member 116 is readily accessible to operator personnel in an independent manner with respect to the dispensing valve assembly nozzle 112. For example, should the filter member need to cleaned, removed, or replaced, the module housing or body 102 can be easily removed or detached from the hot melt adhesive or other thermoplastic material applicator as a result of disengaging the bolt fasteners 104,104, and accordingly, the disposition of the filter member 116, at its axially offset position within the side wall member 110 of the module housing or body 102, with respect to the axial disposition of the dispensing valve assembly nozzle 112 within the underside or lower end wall portion 113 of the module housing or body 102, renders the same immediately accessible without necessitating the removal of the dispensing valve assembly nozzle 112 from the module housing or body 102.

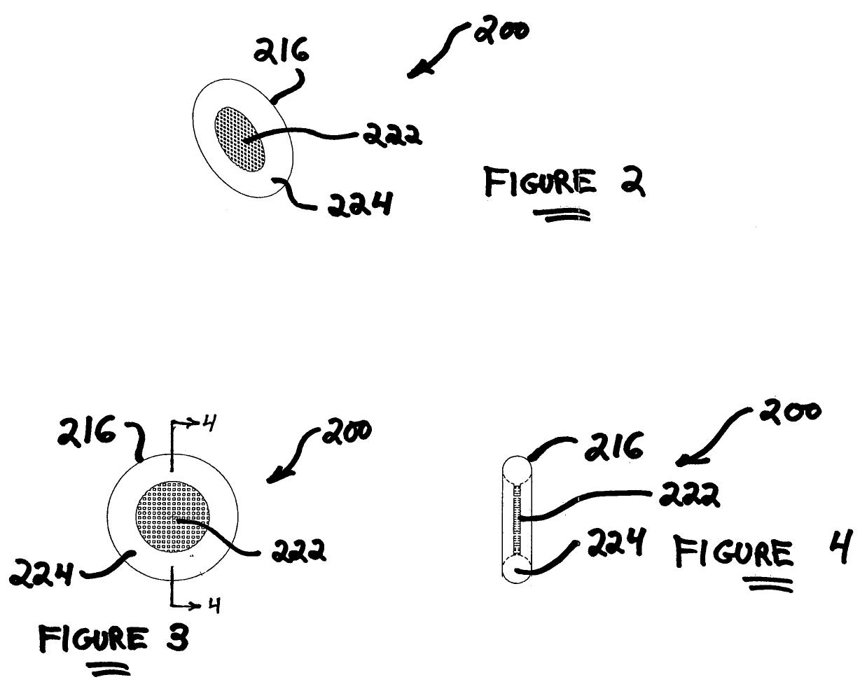

With reference now being made to FIGS. 2-4, a second embodiment of a new and improved module filter assembly, which has also been constructed in accordance with the principles and teachings of the present invention and which can likewise be incorporated within the new and improved hot melt adhesive or other thermoplastic material dispensing valve or module assembly as disclosed within FIG. 1, is disclosed and is generally indicated by the reference character 200. It is to be noted that in view of the similarity between the new and improved second embodiment module filter assembly as disclosed within FIGS. 2-4, and the new and improved first embodiment module filter assembly as disclosed within FIG. 1, component parts of the second embodiment module filter assembly as disclosed within FIGS. 2-4, which correspond to component parts of the first embodiment module filter assembly as disclosed within FIG. 1, will be designated by corresponding reference characters except that they will be within the 200 series.

More particularly, it is seen that the new and improved second embodiment module filter assembly 200 is seen to comprise an inline filter member 216 which comprises an axially central porous or mesh portion 222 integrally disposed internally within a surrounding O-ring sealing member 224, and that, as was the case with the axially central porous or mesh portion 122 of the inline filter member 116 as disclosed within FIG. 1, the axially central porous or mesh portion 222 of the inline filter member 216 may be fabricated from a 100 mesh stainless steel filter screen component. The integral inline filter member 216 may then be incorporated, for example, within a countersunk or recessed region of a module housing or body similar to the recessed or countersunk region 118 of the side wall member 110 of the module housing or body 102, it being of course appreciated that, as a result of integrally incorporating the porous or mesh portion 222 within the surrounding O-ring sealing member 224, the actual filtering section of the overall integral inline filter member 216 would automatically be inserted, installed, and properly positioned within the recessed or countersunk region of the module housing or body as a result of the insertion, installation, and positioning of the O-ring sealing member 224 within the recessed or countersunk region of the module housing or body.

Still further, it is also to be appreciated that, as was the case with the first embodiment inline filter member 116 as disclosed within FIG. 1, as a result of the disposition of the dispensing valve assembly nozzle 112 within the underside or lower end wall portion 113 of the dispensing valve or module assembly housing or body 102, and as a result of the disposition of the filter member 216 within, for example, the side wall member 110 of the module housing or body 102, the filter member 216 is also effectively disposed at an offset position with respect to the axis 126 of the dispensing valve assembly nozzle 112. Therefore, while the filter member 216 comprises an inline filter member with respect to the dispensing valve assembly 112 as defined by means of the fluid flow path of the incoming hot melt adhesive or other thermoplastic material which extends from the applicator head or the like, not shown, into the hot melt adhesive or other thermoplastic material inlet port 114, and then to the dispensing valve assembly nozzle 112, it can also be readily appreciated that the inline filter member 216 is readily accessible to operator personnel in an independent manner with respect to the dispensing valve assembly nozzle 112. Accordingly, should the filter member need to cleaned, removed, or replaced, the module housing or body 102 can be easily removed or detached from the hot melt adhesive or other thermoplastic material applicator as a result of disengaging the bolt fasteners 104,104, and therefore, the disposition of the filter member 216, at its axially offset position within the side wall member 110 of the module housing or body 102, with respect to the axial disposition of the dispensing valve assembly nozzle 112 within the underside or lower end wall portion 113 of the module housing or body 102, renders the same immediately accessible without necessitating the removal of the dispensing valve assembly nozzle 112 from the module body or housing 102.

Thus, it may be seen that in accordance with the principles and teachings of the present invention, there has been disclosed a new and improved hot melt adhesive or other thermoplastic material dispensing valve or module assembly which is adapted to be operatively associated with and fixedly mounted upon a hot melt adhesive or other thermoplastic material applicator and which has a new and improved module filter assembly disposed therewithin for trapping minute particles or debris which could otherwise clog or block the hot melt adhesive or other thermoplastic material dispensing valve assembly nozzle. The new and improved module filter assembly is mounted upon or within a module housing or body of the dispensing valve or module assembly at a position which is disposed substantially immediately upstream of the dispensing valve assembly nozzle but at a position which is, in effect, offset from the longitudinal axis of the dispensing valve assembly nozzle so as to not only be readily accessible when the dispensing valve or module assembly is detached from the hot melt adhesive or other thermoplastic material applicator in connection with, for example, the performance of a filter removal, cleaning, or replacement operation, but in addition, the new and improved module filter assembly is also effectively independent of the dispensing valve assembly nozzle such that the dispensing valve assembly nozzle does not have to be detached or removed from the dispensing valve or module assembly in order to gain access to the module filter assembly. In accordance with a first embodiment of the module filter assembly, the module filter is secured within the dispensing valve assembly or module housing by means of an O-ring sealing member, while in accordance with a second embodiment of the module filter assembly, the module filter is disposed internally within the O-ring sealing member and forms an integral assembly therewith.

Obviously, many variations and modifications of the present invention are possible in light of the above teachings. It is therefore to be understood that within the scope of the appended claims, the present invention may be practiced otherwise than as specifically described herein.

What is claimed as new and desired to be protected by Letters Patent of the United States of America, is:

1. A fluid dispensing valve assembly, comprising:
a module housing having a longitudinal axis and within which there is disposed an axially movable dispensing valve member;
a fluid dispensing nozzle fixedly mounted upon a first side wall member of said module housing for dispensing a fluid to be dispensed;
first and second control air ports defined within said module housing for conducting incoming control air into said module housing for controlling the axial movement of the dispensing valve member between a first seated position at which the dispensing of the fluid from said fluid dispensing nozzle is prevented, and a second unseated position at which the dispensing of the fluid from said fluid dispensing nozzle is permitted;
a fluid inlet port defined within a second side wall member of said module housing for permitting fluid, to be dispensed, to enter said module housing and to be conducted toward the axially movable dispensing valve member and said fluid dispensing nozzle so as to be dispensed from said fluid dispensing nozzle when the axially movable dispensing valve member is disposed at said second unseated position; and
a nozzle filter mounted upon said second side wall member of said module housing and operatively associated with said fluid inlet port so as to be disposed at a position upstream of said fluid dispensing nozzle for filtering particle debris, which may be disposed within said fluid, so as to prevent such particle debris from clogging said fluid dispensing nozzle.

2. The fluid dispensing valve assembly as set forth in claim 1, wherein:
said nozzle filter is mounted upon said second side wall member of said module housing so as to be externally accessible.

3. The fluid dispensing valve assembly as set forth in claim 2, wherein:
as a result of said nozzle filter being mounted upon said second side wall member of said module housing so as to be externally accessible, said nozzle filter is accessible independently of said fluid dispensing nozzle.

4. The fluid dispensing valve assembly as set forth in claim 1, wherein:
said nozzle filter is mounted within a countersunk recessed portion of said second side wall member of said module housing.

5. The fluid dispensing valve assembly as set forth in claim 4, further comprising:
an O-ring sealing member disposed within said countersunk recessed portion of said second side wall member of said module housing so as to maintain said nozzle filter mounted within said countersunk recessed portion of said second side wall member of said module housing.

6. The fluid dispensing valve assembly as set forth in claim 1, wherein:
said nozzle filter is fabricated from stainless steel.

7. The fluid dispensing valve assembly as set forth in claim 6, wherein:
said nozzle filter comprises a 100 mesh stainless steel filter screen component.

8. The fluid dispensing valve assembly as set forth in claim 1, wherein said nozzle filter comprises:
an annular O-ring sealing member; and
a nozzle filter component integrally fixed to said annular O-ring sealing member at an axially central position within said annular O-ring sealing member.

9. The fluid dispensing valve assembly as set forth in claim 8, wherein:
said nozzle filter is fabricated from stainless steel.

10. The fluid dispensing valve assembly as set forth in claim 9, wherein:
said nozzle filter comprises a 100 mesh stainless steel filter screen component.

11. The fluid dispensing valve assembly as set forth in claim 1, wherein:
said second side wall member of said module housing, within which said fluid inlet port is defined and upon which said nozzle filter is mounted, is substantially perpendicular to said first side wall member of said module housing upon which said fluid dispensing nozzle is mounted.

12. The fluid dispensing valve assembly as set forth in claim 11, wherein:
as a result of said nozzle filter being mounted upon said second side wall member of said module housing, which is disposed substantially perpendicular to said first side wall member of said module housing upon which said fluid dispensing nozzle is mounted, said nozzle filter comprises an inline but offset nozzle filter with respect to said fluid dispensing nozzle.

13. The fluid dispensing valve assembly as set forth in claim 1, wherein:
said first side wall member of said module housing, upon which said fluid dispensing nozzle is mounted, comprises an undersurface wall member of said module housing.

14. The fluid dispensing valve assembly as set forth in claim 13, wherein:
said fluid dispensing nozzle is disposed upon said undersurface wall member of said module housing in a coaxial manner with respect to said longitudinal axis of said module housing.

15. The fluid dispensing valve assembly as set forth in claim 14, wherein:
as a result of said nozzle filter being mounted upon said second side wall member of said module housing, which is disposed substantially perpendicular to said first side wall member of said module housing upon which said fluid dispensing nozzle is mounted, said nozzle filter comprises an inline but axially offset nozzle filter with respect to said fluid dispensing nozzle.

16. The fluid dispensing valve assembly as set forth in claim 1, wherein:
said first and second control air ports, defined within said module housing for conducting incoming control air into said module housing for controlling the axial movement of the dispensing valve member between the first seated position and the second unseated position, are defined within said second side wall member of said module housing.

17. The fluid dispensing valve assembly as set forth in claim 1, wherein:
said fluid dispensing valve assembly comprises a hot melt adhesive dispensing valve assembly for dispensing hot melt adhesive material.
